(19) United States
(12) Patent Application Publication
(10) Pub. No.: US 2025/0282166 A1
(43) Pub. Date: Sep. 11, 2025

(54) LAYER FORMATION METHOD, SUBSTRATE REGENERATION METHOD, AND PRINTED MATTER PRODUCTION METHOD

(71) Applicant: BROTHER KOGYO KABUSHIKI KAISHA, Nagoya (JP)

(72) Inventors: Takayuki HIGUCHI, Anpachi (JP); Takefumi KAWAKAMI, Nagoya (JP)

(73) Assignee: BROTHER KOGYO KABUSHIKI KAISHA, Nagoya (JP)

(21) Appl. No.: 19/072,014

(22) Filed: Mar. 6, 2025

(30) Foreign Application Priority Data
Mar. 8, 2024 (JP) 2024-036242

(51) Int. Cl. B41M 5/00; B41M 5/52; B41M 7/00

(52) U.S. Cl. CPC B41M 5/0017; B41M 5/0064; B41M 5/5209; B41M 7/0081

(57) ABSTRACT

A layer formation method includes: an application step of applying or ejecting, onto a substrate, an aqueous composition containing water and a polymerizable compound that is soluble in water and that undergoes a polymerization reaction due to irradiation with an electron beam; and a drying step of drying the aqueous composition applied or ejected onto the substrate, in which the aqueous composition is free of a photopolymerization initiator excitable by ultraviolet light, and a coating layer, which is peelable from the substrate, is formed on the substrate using the aqueous composition.

### REFERENCE TO RELATED APPLICATIONS

This application claims priority from Japanese Patent Application No. 2024-036242 filed on Mar. 8, 2024. The entire content of the priority application is incorporated herein by reference.

### BACKGROUND ART

In recent years, recycling has been attracting attention due to growing environmental awareness. In the field of printing, there is a growing need to remove an ink from a package or the like of a product that has been subjected to printing after use of the product, and to recycle a substrate constituting the package. For example, a package using plastics or a plastic product such as a plastic bottle causes an environmental pollution issue in the oceans. For example, since the plastics are difficult to decompose in nature, some of them are classified, collected, and recycled. However, when a plastic product that has been subjected to printing or the like is mixed in during the recycling process, the recycled product may be discolored and may not be able to be reused. Such a plastic product that has been subjected to printing or the like is often discarded rather than reused. In the case where the discarded plastic product ends up in the oceans, the plastic product breaks down in seawater and becomes microplastics. When marine organisms such as fish ingest the microplastics, the microplastics are concentrated in the bodies of the marine organisms. At this time, there is concern that when humans ingest such marine organisms as food, it could have an adverse influence on human health. Such an issue is not limited to plastics, and may also be an issue with other substrates that have been subjected to printing.

From the viewpoint of recycling the substrates that have been subjected to printing or the like, methods for removing a printed matter from the substrates have been studied in the related art. For example, there has been disclosed a recording medium forming method that includes a step of forming, on a surface of a hydrophobic transparent recording medium, a removable film including an adhesive layer containing an ultraviolet-curable component and a substrate layer, and a step of forming an image on a surface of the substrate layer of the removable film. In the above recording medium forming method, in the case of reusing the transparent recording medium, an operator irradiates the removable film with ultraviolet light to cause a polymerization reaction of the ultraviolet-curable component, thereby shrinking the removable film. As a result, an adhesion force of the removable film to the transparent recording medium decreases, and the removable film is removed from the transparent recording medium.

### SUMMARY

According to an aspect of the present disclosure, a layer formation method includes: an application step of applying or ejecting, onto a substrate, an aqueous composition containing water and a polymerizable compound that is soluble in water and that undergoes a polymerization reaction due to irradiation with an electron beam; and a drying step of drying the aqueous composition applied or ejected onto the substrate, in which the aqueous composition is free of a photopolymerization initiator excitable by ultraviolet light, and a coating layer, which is peelable from the substrate, is formed on the substrate using the aqueous composition.

According to another aspect of the present disclosure, a substrate regeneration method includes: an irradiation step of irradiating the coating layer formed by using the above layer formation method with an electron beam at a dose in a range of 1 kGy to 150 kGy.

According to a further aspect of the present disclosure, a substrate regeneration method includes: an irradiation step of irradiating the coating layer formed by using the above layer formation method with an electron beam at a dose in a range of 30 kGy to 100 kGy.

According to a further aspect of the present disclosure, a printed matter production method includes: an application step of applying or ejecting, onto a substrate, an aqueous composition containing water and a polymerizable compound that is soluble in water and that undergoes a polymerization reaction due to irradiation with an electron beam; and a drying step of drying the aqueous composition applied or ejected onto the substrate, in which the aqueous composition is free of a photopolymerization initiator excitable by ultraviolet light, and a printing layer, which is peelable from the substrate, is formed on the substrate using the aqueous composition.

### BRIEF DESCRIPTION OF THE DRAWINGS

FIG. 1 is a simplified configuration diagram of an image recording apparatus 10 in which a layer formation method is to be used.

FIG. 2 is a schematic diagram of a coating layer 7 formed on an upper surface 6a of a sheet 6 by using the layer formation method.

FIG. 3 is a diagram illustrating a state where adhesion between the coating layer 7 and the sheet 6 decreases when a printed matter 9 is irradiated with an electron beam by using a substrate regeneration method.

FIG. 4 is a schematic diagram of a coating layer 12 and a coloring material layer 11 formed by using a layer formation method.

### DESCRIPTION

Hereinafter, a preferred embodiment of the present disclosure will be described. Note that, the present embodiment is merely one embodiment of the present disclosure, and it is needless to say that the embodiment can be modified without changing the gist of the present disclosure.

### Internal Configuration of Image Recording Apparatus 10

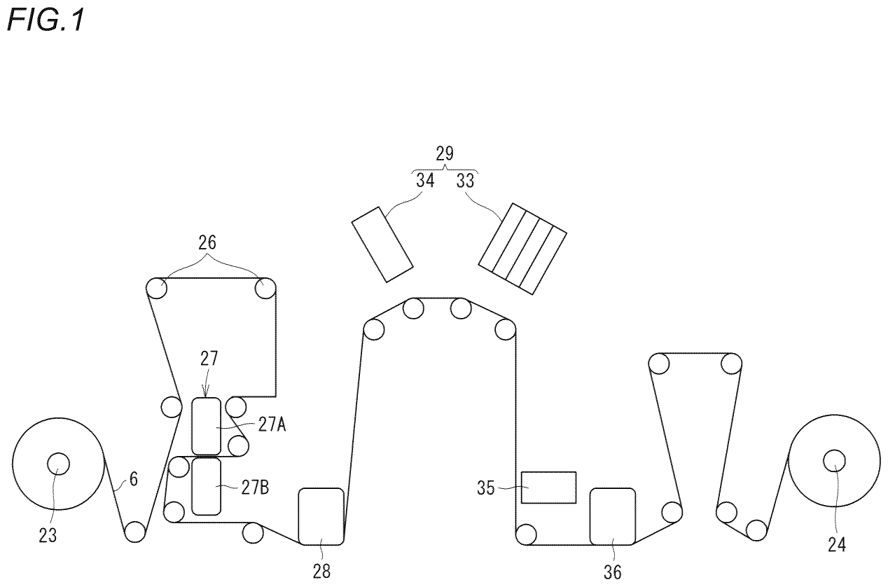

As shown in FIG. 1, an image recording apparatus 10 to be used in a layer formation method and a printed matter production method according to the present disclosure includes, in a housing (not shown), a supply roll 23, a plurality of conveying shafts 26, a web cleaner 27, a tension controller 28, a recording unit 29, a heater 35, a tension controller 36, and a rewinder 24. The image recording apparatus 10 records an image on a sheet 6.

The sheet 6 is an example of a substrate. The sheet 6 is a sheet cut to a predetermined dimension. The sheet 6 is a transparent non-permeable substrate. The non-permeable substrate is a substrate that has a surface having low water permeability. Specifically, the non-permeable substrate refers to a substrate having a water absorption amount of 10 mL/m² or less from the start of contact to 30 msec^{1/2} in a Bristow method. In addition, the “non-permeable or low-permeable” may refer to a water absorption rate of less than 0.5% in 24 hours measured in accordance with ASTM D570. More specifically, the “non-permeable” may refer to a water absorption rate of less than 0.2%, and the “low-permeable” may refer to a water absorption rate of 0.2% or more and less than 0.5%. Note that, the unit “%” of the water absorption rate is based on mass. Examples of a material of the transparent non-permeable substrate include plastics (for example, a polypropylene, a polyethylene, a polyethylene terephthalate, a polyvinyl chloride resin, and a polycarbonate). The transparent non-permeable substrate is suitably in the form of a film or a plate. Note that, the non-permeable substrate may not be transparent.

The sheet 6 may be a permeable substrate. In this case, the sheet 6 may be one drawn from a roll in which the sheet is wound in a cylindrical shape, or may be of a fanfold type. Examples of the permeable substrate include plain paper and coated paper. The “coated paper” refers to, for example, one obtained by applying a coating agent to plain paper made from pulp, such as high-grade printing paper or medium-grade printing paper to improve smoothness, whiteness, glossiness, and the like. Specific examples thereof include high-quality coated paper and medium-quality coated paper.

The supply roll 23 is located at a lower portion of the housing. The sheet 6 is wound around the supply roll 23. The supply roll 23 is rotated by a motor (not shown). The rotating supply roll 23 feeds the sheet 6 onto the plurality of conveying shafts 26.

The plurality of conveying shafts 26 are rotated by a motor (not shown). The plurality of rotating conveying shafts 26 convey the sheet 6 fed out from the supply roll 23.

The web cleaner 27 is located upstream of the recording unit 29 in a conveying direction of the sheet 6. The web cleaner 27 includes a rubber roller 27A and an adhesive roller 27B. The web cleaner 27 captures dust adhering to the sheet 6 with the rubber roller 27A and transfers the dust to the adhesive roller 27B, thereby cleaning the sheet 6.

The tension controller 28 is located upstream of the recording unit 29 in the conveying direction of the sheet 6. The tension controller 28 adjusts a tension applied to the sheet 6.

The recording unit 29 includes a printing head 34 (an example of an inkjet head) and a printing head 33. The printing head 34 is located downstream of the tension controller 28 in the conveying direction of the sheet 6. The printing head 34 may be a so-called serial head, or a so-called line head. The printing head 34 has a flow path therein through which an aqueous composition to be described later flows. The flow path is in communication with a tank through a tube. That is, the aqueous composition stored in the tank is supplied to the printing head 34 through the tube. The printing head 33 is located downstream of the printing head 34 in the conveying direction of the sheet 6. The printing head 33 includes inkjet heads for four colors: cyan, magenta, yellow, and black.

The heater 35 is located downstream of the printing head 33 in the conveying direction of the sheet 6. The heater 35 is a so-called halogen heater. The heater 35 includes a halogen lamp, which is a heating element that emits infrared light, a reflective plate, and a housing. Through openings in the housing, heat from the halogen lamp and the reflective plate is radiated to the outside or is blocked.

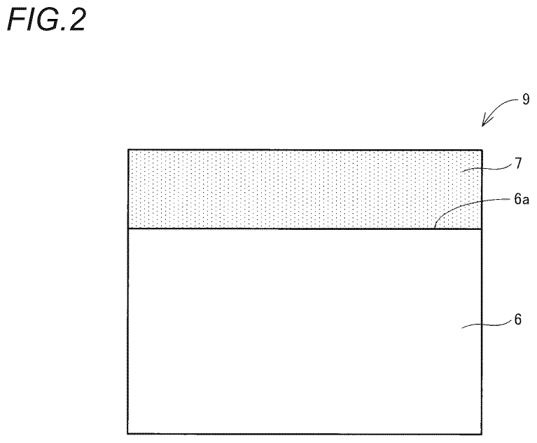

The heater 35 heats at least one of the sheet 6 passing near the heater 35 and the aqueous composition adhering to the sheet 6. In the present embodiment, the heater 35 heats both the sheet 6 and the aqueous composition. When the aqueous composition is heated, a binder resin in the aqueous composition, to be described later, softens and forms a coating layer 7 on the sheet 6 as shown in FIG. 2. Then, the sheet 6 and the coating layer 7 passing near the heater 35 are cooled, and thereby the coating layer 7 is solidified. Accordingly, the coating layer 7 is fixed to the sheet 6. Note that, the heater 35 is not limited to a halogen heater, as long as it is capable of heating the sheet 6 or the aqueous composition. For example, the heater 35 may be a carbon heater, a dryer, an oven, a belt conveyor oven, or the like.

The tension controller 36 is located downstream of the heater 35 in the conveying direction of the sheet 6. The tension controller 36 adjusts a tension applied to the sheet 6.

The rewinder 24 is located at the most downstream side of the conveying path. The rewinder 24 winds up the sheet 6 conveyed by the plurality of conveying shafts 26.

### Composition of Aqueous Composition

Hereinafter, details of the aqueous composition will be described. The aqueous composition contains a polymerizable compound, a binder resin, a coloring material, an organic solvent, a surfactant, and water. The aqueous composition is free of a photopolymerization initiator excitable by ultraviolet light. Some photopolymerization initiators generate an odor and cause migration, and being free of a photopolymerization initiator is to avoid the issues of odor and migration. In addition, it is to prevent the coating layer 7 from peeling off from the sheet 6 due to a polymerization reaction of the polymerizable compound contained in the coating layer 7 caused by natural light. The aqueous composition is an aqueous ink in which a polymerizable compound, a binder resin, a coloring material, and an organic solvent are dissolved in water.

The polymerizable compound is a water-soluble compound that is soluble in water and that undergoes a polymerization reaction due to irradiation with an electron beam. The polymerizable compound is in a state of being dissolved in water. The state where the polymerizable compound is dissolved in water refers to a state where 1 wt % or more of the polymerizable compound is dissolved in 100 g of water. Examples of the polymerizable compound include N,N′-1,2-ethanediylbis{N-[2-(acryloylamino)ethyl]acrylamide}, N,N′-(((2-acrylamido-2((3-(buta-1,3-diene-2-ylamino)propoxy-1,3-diyl)bis(oxy))bis(propane-3,1-diyl))diacrylamide, N,N-bis(2-acrylamidoethyl)acrylamide, N,N′-{oxybis(2,1-ethanediyloxy-3,1-propanediyl)}bisacrylamide, 4-[(3-methacrylamidopropyl)dimethylammonio]butane-1-sulfonic acid, 2-(methacryloyloxy)ethyl 2-(trimethylammonio)ethyl phosphate, polyethylene glycol dimethacrylate, N-isopropylacrylamide, hydroxypropyl methacrylate, 2-hydroxyethyl methacrylate, 2-hydroxypropyl methacrylate, N-vinylacetamide, N-methoxymethylmethacrylamide, a bisphenol A ethylene oxide adduct diacrylate, polyethylene glycol monomethyl ether methacrylate, and 2-hydroxy-3-phenoxypropyl acrylate. Among them, preferred are N,N′-1,2-ethanediylbis{N-[2-(acryloylamino)ethyl]acrylamide}, N,N′-(((2-acrylamido-2((3-(buta-1,3-diene-2-ylamino)propoxy-1,3-diyl)bis(oxy))bis(propane-3,1-diyl))diacrylamide, N,N-bis(2-acrylamidoethyl)acrylamide, and N,N′-{oxybis(2,1-ethanediyloxy-3,1-propanediyl)}bisacrylamide, which have two or more acrylamide functional groups. A solid content of the polymerizable compound in a total amount of ink is, for example, preferably in a range of 1.0 wt % or more and 40.0 wt % or less, more preferably in a range of 2.5 wt % or more and 40.0 wt % or less, and particularly preferably in a range of 5.0 wt % or more and 40 wt % or less.

The binder resin is used to fix the coating layer 7 made from an aqueous composition to the sheet 6. As the binder resin, for example, a commercially available product can be used. The binder resin may contain, for example, styrene and vinyl chloride as a monomer. The binder resin may be in a state of being dissolved in the aqueous composition or the aqueous composition may be in an emulsion state where the binder resin is dispersed as resin particles. These binder resins may be used alone or in combination of two or more kinds thereof. Examples of the binder resin include an acrylic resin, a maleic acid-based ester resin, a vinyl acetate-based resin, a carbonate-based resin, a polycarbonate-based resin, a styrene-based resin, an ethylene-based resin, a polyethylene-based resin, a propylene-based resin, a polypropylene-based resin, a urethane-based resin, a polyurethane-based resin, a polyester-based resin, and a copolymer resin thereof.

As the binder resin, a resin having a glass transition temperature (Tg) in a range of, for example, −30° C. or higher and 200° C. or lower is used. The glass transition temperature (Tg) is more preferably −30° C. or higher and 180° C. or lower, and still more preferably −30° C. or higher and 150° C. or lower.

As the emulsion, for example, a commercially available product may be used. Examples of the commercially available product include “SUPERFLEX (registered trademark) 870” (Tg: 71° C.) and “SUPERFLEX (registered trademark) 150” (Tg: 40° C.) manufactured by DKS Co., Ltd., “Mowinyl (registered trademark) 6760” (Tg: −28° C.) and “Mowinyl (registered trademark) DM774” (Tg: 33° C.) manufactured by Japan Coating Resin co., ltd., “POLYZOL (registered trademark) AP-3270N” (Tg: 27° C.) manufactured by Showa Denko Materials co., Ltd., and “HILOS-X (registered trademark) KE-1062” (Tg: 112° C.) and “HILOS-X (registered trademark) QE-1042” (Tg: 69° C.) manufactured by SEIKO PMC CORPORATION. “SUPERFLEX” is a registered trademark of DKS Co., Ltd. “Mowinyl” is a registered trademark of Japan Coating Resin co., ltd. “POLYZOL” is a registered trademark of Showa Denko Materials co., Ltd. “HILOS-X” is a registered trademark of SEIKO PMC CORPORATION.

The binder resin has an average particle diameter, for example, in a range of 30 nm or more and 200 nm or less. The average particle diameter can be measured as an arithmetic mean diameter using, for example, a dynamic light scattering particle size distribution analyzer “LB-550” manufactured by Horiba, Ltd.

A content (R) of the binder resin in the total amount of ink is, for example, preferably in a range of 0.1 wt % or more and 30 wt % or less, more preferably in a range of 0.5 wt % or more and 20 wt % or less, and particularly preferably in a range of 1.0 wt % or more and 15.0 wt % or less. The binder resin may be used alone or in combination of two or more kinds thereof.

The coloring material is, for example, a pigment that can be dispersed in water by using a resin for pigment dispersion (a resin dispersant). Examples of the coloring material include carbon black, an inorganic pigment, and an organic pigment. Examples of the carbon black include furnace black, lamp black, acetylene black, and channel black. Examples of the inorganic pigment include titanium oxide, an iron oxide-based inorganic pigment, and a carbon black-based inorganic pigment. Examples of the organic pigment include: azo pigments such as azo lake, an insoluble azo pigment, a condensed azo pigment, and a chelate azo pigment; polycyclic pigments such as a phthalocyanine pigment, a perylene and perinone pigment, an anthraquinone pigment, a quinacridone pigment, a dioxazine pigment, a thioindigo pigment, an isoindolinone pigment, and a quinophthalone pigment; dye lake pigments such as a basic dye lake pigment and an acid dye lake pigment; nitro pigments; nitroso pigments; and aniline black daylight fluorescent pigments.

A solid content of the coloring material in the total amount of ink is not particularly limited, and can be appropriately determined depending on, for example, a desired optical density or chroma. The solid content of the coloring material is, for example, preferably in a range of 0.1 wt % or more and 20.0 wt % or less, and more preferably in a range of 1.0 wt % or more and 15.0 wt % or less. The solid content of the coloring material is the weight of the pigment alone, and does not include the weight of the binder resin. The coloring material may be used alone or in combination of two or more kinds thereof.

The organic solvent is a solvent uniformly mixed with water when mixed in a ratio of 1:1. The organic solvent is not particularly limited, and any solvent can be used. Examples of the organic solvent include propylene glycol, ethylene glycol, 1,2-butanediol, propylene glycol propyl ether, dipropylene glycol propyl ether, diethylene glycol monobutyl ether, and 1,6-hexanediol. Propylene glycol or 1,2-butanediol is preferred. Examples of other organic solvents include: alkyl alcohols having 1 to 4 carbon atoms, such as methyl alcohol, ethyl alcohol, n-propyl alcohol, isopropyl alcohol, n-butyl alcohol, sec-butyl alcohol, and tert-butyl alcohol; alkylene glycols containing an alkylene group having 2 to 6 carbon atoms, such as ethylene glycol, propylene glycol, butylene glycol, triethylene glycol, 1,2,6-hexanetriol, thiodiglycol, hexylene glycol, and diethylene glycol; lower alkyl ethers of alkylene glycols such as glycerin, ethylene glycol monomethyl (or ethyl, propyl, butyl) ether, diethylene glycol monomethyl (or ethyl, propyl, butyl) ether, triethylene glycol monomethyl (or ethyl, propyl, butyl, hexyl) ether, tetraethylene glycol monomethyl (or ethyl, propyl, butyl, hexyl) ether, propylene glycol monomethyl (or ethyl, propyl, butyl) ether, dipropylene glycol monomethyl (or ethyl, propyl, butyl) ether, tripropylene glycol monomethyl (or ethyl, propyl, butyl) ether, and tetrapropylene glycol monomethyl (or ethyl) ether; N-methyl-2-pyrrolidone; 2-pyrrolidone; and 1,3-dimethyl-2-imidazolidinone.

A content of the organic solvent in the total amount of ink is, for example, preferably in a range of 1 wt % or more and 70 wt % or less, and more preferably in a range of 3 wt % or more and 50 wt % or less.

The water is preferably ion exchange water or pure water. A content of the water in the total amount of ink is, for example, preferably in a range of 15 wt % or more and 95 wt % or less, and more preferably in a range of 25 wt % or more and 85 wt % or less. The content of the water may be, for example, the balance except for other components.

The aqueous composition may further contain an additive known in the related art as necessary. Examples of the additive include a surfactant, a pH adjuster, a viscosity adjuster, a surface tension adjuster, a preservative, an antifungal agent, a leveling agent, an antifoaming agent, a light stabilizer, an antioxidant, a nozzle drying inhibitor, a polymer component such as an emulsion, and a dye. The surfactant may further include a nonionic surfactant. As the nonionic surfactant, for example, a commercially available product may be used. Examples of the commercially available product include “OLFINE (registered trademark) E1010”, “OLFINE (registered trademark) E1006”, and “OLFINE (registered trademark) E1004”, which are manufactured by Nissin Chemical co., ltd. “OLFINE” is a registered trademark of Nissin Chemical co., ltd. A content of the nonionic surfactant in the total amount of ink is, for example, 5 wt % or less, 3 wt % or less, or 0.1 wt % to 2 wt %. Examples of the viscosity adjuster include polyvinyl alcohol, cellulose, and a water-soluble resin.

The aqueous composition can be prepared by uniformly mixing, for example, the polymerizable compound, the binder resin, the coloring material, the organic solvent, the water, and other additives if necessary by using a method known in the related art, and removing insoluble matters using a filter or the like.

Next, the layer formation method and the printed matter production method using the image recording apparatus 10 will be described. In the layer formation method and the printed matter production method, an application step and a drying step are carried out in this order. Hereinafter, reference is made to FIG. 1 and FIG. 2.

In the application step, the aqueous composition is ejected onto the sheet 6. Specifically, in the application step, a printing step of ejecting the aqueous composition as droplets from the printing head 34 toward an upper surface 6a of the sheet 6 whose tension has been adjusted by the tension controller 28 is executed. Note that, in the application step, the aqueous composition may be applied to the sheet 6.

After the application step, the drying step is executed. In the drying step, the aqueous composition ejected onto the sheet 6 is dried. Specifically, in the drying step, both the sheet 6 and the aqueous composition passing below openings in the heater 35 are dried by radiant heat from the heater 35. A drying temperature is in a range of 40° C. to 230° C. The drying temperature is more preferably in a range of 50° C. to 220° C. The drying temperature is particularly preferably in a range of 50° C. to 150° C. When the drying step is executed, once the binder resin in the aqueous composition softens to form a film, the coating layer 7 (an example of a printing layer) including a coloring material and a transparent clear layer made from the binder resin is formed on the upper surface 6a of the sheet 6. Thereafter, the sheet 6 and the coating layer 7 are cooled, and thereby the coating layer 7 is solidified. As a result, as shown in FIG. 2, the coating layer 7 is fixed to the upper surface 6a of the sheet 6. The coating layer 7 contains a polymerizable compound. Note that, the drying step may be omitted.

Note that, in the present disclosure, the “printing” means reproducing characters, pictures, photographs, and the like by selectively applying or ejecting an ink. The “printing” includes not only so-called ink jet printing but also screen printing. The “printing layer” refers to a layer formed by selectively applying or ejecting an ink.

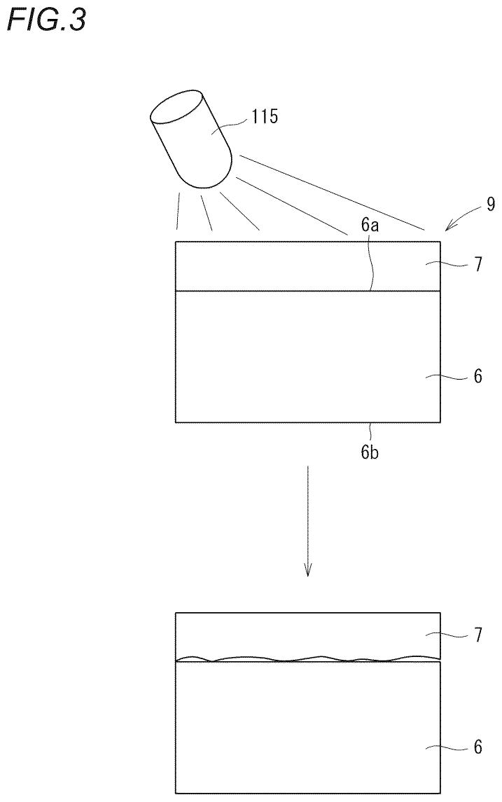

Next, a substrate regeneration method in which the coating layer 7 is peeled off from a printed matter 9 (see FIG. 3) produced by using the layer formation method and the printed matter production method will be described. The substrate regeneration method is carried out when recycling the sheet 6 after the printed matter 9 is produced by using the layer formation method and the printed matter production method. In the substrate regeneration method, an irradiation step is carried out.

In the irradiation step, as shown in FIG. 3, the upper surface 6a (an example of a surface) of the sheet 6 on which the coating layer 7 is formed is irradiated with an electron beam. The electron beam is a flow of a large number of electrons, and when the electron beam hits a substance, secondary electrons or X rays are emitted or a diffraction action, a fluorescence action, an ionization action, a photographic action, and the like are exhibited. When the upper surface 6a of the sheet 6 on which the coating layer 7 is formed is irradiated with an electron beam from an electron beam irradiation device 115, the polymerizable compound contained in the coating layer 7 undergoes a polymerization reaction. As a result, the coating layer 7 shrinks, and thereby an adhesion force between the coating layer 7 and the sheet 6 decreases, and the coating layer 7 is easily peeled off from the sheet 6.

In order to shrink the coating layer 7, the electron beam for irradiation is, for example, an electron beam at a dose in a range of 1 kGy or more and 150 kGy or less. The electron beam is preferably an electron beam at a dose in a range of 10 kGy or more and 150 kGy or less. The electron beam is more preferably an electron beam at a dose in a range of 30 kGy or more and 100 kGy or less. The electron beam is still more preferably an electron beam at a dose in a range of 50 kGy or more and 100 kGy or less. The dose refers to an absorbed dose (kGy) representing the amount of energy absorbed by a substance per unit mass by irradiation with radiation. For example, the absorbed dose is 1 Gy when 1 J of energy is absorbed per 1 kg.

The electron beam irradiation device for emitting the electron beam is not particularly limited as long as it can emit an electron beam at a specific dose. A known electron beam irradiation device can be used. For example, a curtain type electron beam irradiation device (LB1023, manufactured by EYE ELECTRON BEAM CO., LTD) or a line irradiation type low energy electron beam irradiation device (EB-ENGINE, manufactured by Hamamatsu Photonics K.K.) can be suitably used.

An oxygen concentration in the electron beam irradiation device is preferably 500 ppm or less, more preferably 300 ppm or less, and still more preferably 100 ppm or less. When the irradiation with an electron beam is performed under such a condition, it is possible to prevent generation of ozone, and it is also possible to prevent a radical generated by the irradiation with an electron beam from being deactivated by oxygen in the atmosphere. Such a condition can be achieved by, for example, setting an inert gas (nitrogen, argon, or the like) atmosphere in the electron beam irradiation device.

### Operation and Effect of Embodiment

In the layer formation method and the printed matter production method, since the coating layer 7 formed on the upper surface 6a of the sheet 6 contains a polymerizable compound that initiates a polymerization reaction due to irradiation with an electron beam, even when the coating layer 7 is free of a photopolymerization initiator excitable by ultraviolet light, an operator can irradiate the coating layer 7 with an electron beam to shrink the coating layer 7. As a result, the adhesion force of the coating layer 7 to the sheet 6 decreases, and therefore, the operator can peel off the coating layer 7 from the sheet 6 and reuse the sheet 6. Since the peelable coating layer 7 is a coating layer 7 made from an aqueous composition, the risks to people and the environment can be reduced. Moreover, even in the case where the coating layer 7 is formed on a hydrophobic sheet 6 such as a plastic, adhesion between the coating layer 7 and the sheet 6 can be appropriately controlled, and excessive adhesion can be reduced. Therefore, in a recycling process after printing on the sheet 6 by using the layer formation method and the printed matter production method, the coating layer 7 can be easily peeled off from the sheet 6 by irradiating the coating layer 7 with an electron beam. Therefore, the sheet 6 can be easily reused. In addition, since a change in properties of the sheet 6 due to the incorporation of the photopolymerization initiator can be prevented, reusability of the sheet 6 after the coating layer 7 is peeled off from the sheet 6 can be improved. Therefore, printing can be performed on a wide variety of substrates, including plastics, and the recyclability after printing can be improved. Since the coating layer 7 is free of a photopolymerization initiator excitable by ultraviolet light, an odor of the printed matter 9 after drying is prevented. In addition, since the coating layer 7 after printing is free of a photopolymerization initiator excitable by ultraviolet light, the coating layer 7 after printing does not shrink when exposed to natural light, so that deterioration of the printed matter 9 is prevented. When the polymerizable compound undergoes a polymerization reaction due to irradiation with an electron beam, no heat is generated, so that damage to the sheet 6 is prevented. The electron beam has transmissibility higher than that of ultraviolet light, and therefore can easily cause a polymerization reaction of the polymerizable compound even when the coating layer 7 is thick.

In the layer formation method and the printed matter production method, since the aqueous composition is ejected onto the sheet 6 by the printing head 34, the coating layer 7 can be easily formed on the sheet 6.

In the layer formation method and the printed matter production method, since a printing layer is formed by forming the coating layer 7 on the sheet 6, an extra coating layer can be reduced. In addition, since the coating layer can be formed locally, traces of the aqueous composition can be reduced.

In the layer formation method and the printed matter production method, since the drying step of drying the aqueous composition is carried out after the application step of ejecting the aqueous composition onto the sheet 6, the aqueous composition is easily fixed to the sheet 6. Therefore, the adhesion of the aqueous composition to the sheet 6 is high.

In the layer formation method and the printed matter production method, since the aqueous composition is an aqueous ink containing a coloring material, the application step plays a role of executing printing using the aqueous ink. Therefore, since an image is formed by forming the coating layer 7 on the sheet 6, the printing is easier than a case where a printing step of forming an image is carried out after steps including the application step and the drying step. During recycling, the aqueous composition is peeled off from the sheet 6 by irradiation with an electron beam, thereby playing a role of removing the aqueous ink from the sheet 6. Therefore, it is possible to provide a layer formation method that is environmentally friendly and that enables the sheet 6 to be recycled while having a shortened printing time.

In the layer formation method and the printed matter production method, in the case where the aqueous composition ejected onto the sheet 6 in the application step is dried at a temperature in the range of 50° C. to 220° C. in the drying step, since a film forming property of the binder resin in the aqueous composition is high, the adhesion of the aqueous composition to the sheet 6 is high.

In the layer formation method and the printed matter production method, in the case where the aqueous composition ejected onto the sheet 6 in the application step is dried at a temperature in the range of 50° C. to 150° C. in the drying step, since the film forming property of the binder resin in the aqueous composition is high, the adhesion of the aqueous composition to the sheet 6 is high. In addition, since the temperature at which the sheet 6 is dried in the drying step is 150° C. or lower, the damage to the sheet 6 is prevented.

In the layer formation method and the printed matter production method, since the aqueous composition is in an emulsion state where the binder resin is dispersed in water, when the aqueous composition is dried in the drying step, the binder resin is easily uniformly fixed to the sheet 6.

In the layer formation method and the printed matter production method, since the sheet 6 is a non-permeable substrate, when the application step is executed, the binder resin in the aqueous composition is prevented from permeating the sheet 6. Therefore, in the recycling process for the printed matter 9 produced by using the layer formation method and the printed matter production method, the coating layer 7 can be easily removed by irradiating the printed matter 9 with an electron beam.

In the layer formation method and the printed matter production method, since the sheet 6 is a transparent substrate, when the application step is executed, the binder resin in the aqueous composition is prevented from permeating the sheet 6. Therefore, in the recycling process for the printed matter 9 produced by using the layer formation method and the printed matter production method, the coating layer 7 can be easily removed by irradiating the printed matter 9 with an electron beam.

In the layer formation method and the printed matter production method, in the case of using N,N′-1,2-ethanediylbis{N-[2-(acryloylamino)ethyl]acrylamide}, N,N′-(((2-acrylamido-2((3-(buta-1,3-diene-2-ylamino)propoxy-1,3-diyl)bis(oxy))bis(propane-3,1-diyl))diacrylamide, N,N-bis(2-acrylamidoethyl)acrylamide, and N,N′-{oxybis(2,1-ethanediyloxy-3,1-propanediyl)}bisacrylamide as the polymerizable compound, when the coating layer 7 is irradiated with an electron beam, the coating layer 7 has high peelability from the sheet 6. This is because these four polymerizable compounds have an acrylamide functional group and two or more functional groups. In other words, the larger the number of functional groups in the polymerizable compound, the larger the number of portions where the polymerization reaction occurs, and therefore, the coating layer 7 further shrinks due to the polymerization reaction of the polymerizable compound in the coating layer 7. As the coating layer 7 shrinks, the peelability of the coating layer 7 from the sheet 6 increases.

In the substrate regeneration method, when the printed matter 9 formed by using the layer formation method and the printed matter production method is irradiated with an electron beam at a dose in the range of 1 kGy or more and 150 kGy or less in the irradiation step, the polymerizable compound present in the coating layer 7 on the upper surface 6a of the sheet 6 undergoes a polymerization reaction to shrink the coating layer 7. As a result, the adhesion force of the coating layer 7 to the sheet 6 decreases, and the coating layer 7 is easily peeled off from the sheet 6. Therefore, the sheet 6 can be easily recycled. Compared to a known method of recycling the sheet 6 using a physical method or a chemical method, the damage to the sheet 6 during the recycling process can be prevented, and the number of times the sheet 6 can be regenerated can be increased.

In the substrate regeneration method, when the printed matter 9 formed by using the layer formation method and the printed matter production method is irradiated with an electron beam at a dose in the range of 30 kGy or more and 100 kGy or less in the irradiation step, the polymerizable compound present in the coating layer 7 on the upper surface 6a of the sheet 6 undergoes a polymerization reaction to shrink the coating layer 7. As a result, the adhesion force of the coating layer 7 to the sheet 6 decreases, and the coating layer 7 is easily peeled off from the sheet 6. Therefore, the sheet 6 can be easily recycled. Compared to a known method of recycling the sheet 6 using a physical method or a chemical method, the damage to the sheet 6 during the recycling process can be prevented, and the number of times the sheet 6 can be regenerated can be increased.

In the substrate regeneration method, in the irradiation step, the upper surface 6a of the sheet 6 on which the coating layer 7 is formed is irradiated with an electron beam. Therefore, since the electron beam is likely to hit the polymerizable compound present in the coating layer 7, the polymerization reaction of the polymerizable compound is likely to proceed. Therefore, since the coating layer 7 easily shrinks, the coating layer 7 has high peelability from the sheet 6.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### Modifications

In the layer formation method, in the application step, the printing step of ejecting the aqueous composition as droplets from the printing head 34 toward the upper surface 6a of the sheet 6 is executed. However, a printing step of ejecting a printing ink onto the coating layer 7 may be further executed. In this case, the printing ink is ejected from the printing head 33 onto the coating layer 7, and the aqueous ink serves as a base for the printing using the printing ink. The printing ink is not particularly limited as long as an image can be formed on the coating layer 7.

In this case, the drying step may be executed after the first printing step or may be executed after the second printing step. Alternatively, the drying step may be executed both after the first printing step and after the second printing step. For example, in the case where the printing ink does not require a drying step, the drying step may be executed after the aqueous composition is applied or ejected, and then the printing step may be executed. On the other hand, in the case where the printing ink requires a drying step, the drying step may be executed after the execution of the printing step after the aqueous composition is applied or ejected, or the drying step may be executed after the aqueous composition is applied or ejected, then the printing step may be executed, and the drying step may be executed again.

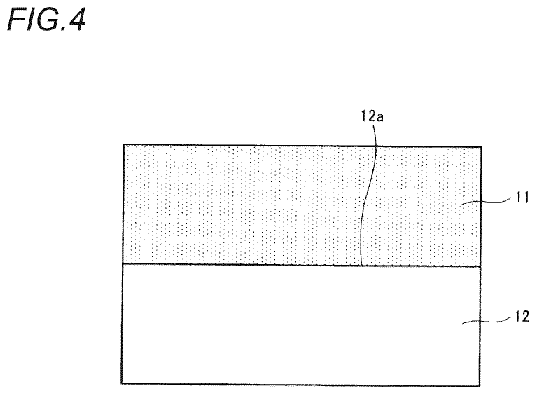

The aqueous composition contains a coloring material, but the coloring material may be omitted. In this case, the drying step may be executed after an aqueous composition free of a coloring material is applied to the sheet 6 in the application step. A transparent coating layer 12 made from a binder resin is formed on the sheet 6. After the drying step, a printing step of ejecting the printing ink onto the coating layer 12 may be executed. In this case, the aqueous composition free of a coloring material is ejected from the printing head 34. The printing ink is ejected from the printing head 33. The aqueous composition plays a role of a base for the printing using the printing ink. Note that, the drying step may be executed after the application step and the printing step. When the printing step is executed, as shown in FIG. 4, a coloring material layer 11 made from a coloring material contained in the printing ink is formed on an upper surface 12a of the transparent coating layer 12 free of the coloring material. Note that, in FIG. 4, the sheet 6 is omitted for simplification of illustration. In this case, a printing layer is formed by the coating layer 12 and the coloring material layer 11. During recycling, the coating layer 12 is peeled off from the sheet 6 together with the coloring material layer 11 by irradiation with an electron beam, thereby playing a role of removing the coloring material layer 11 from the sheet 6. Therefore, it is possible to provide a layer formation method that is environmentally friendly and that enables the sheet 6 to be recycled.

In the substrate regeneration method, the upper surface 6a of the sheet 6 on which the coating layer 7 is formed is irradiated with an electron beam in the irradiation step. However, a lower surface 6b (an example of a back surface) of the sheet 6 opposite to the upper surface 6a may be irradiated with an electron beam. Accordingly, the coating layer 7 can be shrunk by causing a polymerization reaction of the polymerizable compound present in the coating layer 7 while preventing the deterioration of the upper surface 6a of the sheet 6 on which the coating layer 7 is formed.

In the substrate regeneration method, the upper surface 6a or the lower surface 6b of the sheet 6 on which the coating layer 7 is formed is irradiated with an electron beam in the irradiation step. However, it is sufficient that the upper surface 6a or the lower surface 6b of the sheet 6 on which the coating layer 7 is formed is irradiated with an ionizing radiation beam including an electron beam. Examples of the ionizing radiation beam include an electron beam, an α ray, a β ray, a neutral beam, a proton beam, an X ray, and a γ ray. An electron beam is preferred. This is because the electron beam has directivity as compared with an X ray or a γ ray which is an electromagnetic wave among the ionizing radiation beam, and has a high absorbed dose rate (processing capability). The absorbed dose rate (kGy/s) refers to the absorbed dose absorbed per unit time.

### EXAMPLES

Hereinafter, Examples of the present disclosure will be described.

### Example 1

The aqueous composition used was one containing 5.0 wt % of N,N′-1,2-ethanediylbis{N-[2-(acryloylamino)ethyl]acrylamide} as a polymerizable compound, 5.0 wt % of Mowinyl 6760 as a binder resin, 10.0 wt % of propylene glycol as an organic solvent, and ion exchange water as a solvent, being the balance. The drying temperature in the drying step was set to 90° C. In the irradiation step, the upper surface of the sheet on which the coating layer was formed was irradiated with an electron beam having a dose of 60 kGy.

### Example 2

It is different from Example 1 in that 5.0 wt % of Mowinyl 6960 (manufactured by Japan Coating Resin co., ltd.) is used as the binder resin. Other conditions are the same as those in Example 1.

### Example 3

It is different from Example 1 in that 5.0 wt % of Mowinyl 6901 (manufactured by Japan Coating Resin co., ltd.) is used as the binder resin. Other conditions are the same as those in Example 1.

### Example 4

It is different from Example 1 in that 5.0 wt % of SUPERFLEX 460 (manufactured by DKS Co., Ltd.) is used as the binder resin. Other conditions are the same as those in Example 1.

### Example 5

It is different from Example 1 in that 5.0 wt % of Mowinyl 6800 (manufactured by Japan Coating Resin co., ltd.) is used as the binder resin. Other conditions are the same as those in Example 1.

### Example 6

It is different from Example 1 in that a black ink (LC3139 manufactured by Brother Industries, Ltd.) is further used. Other conditions are the same as those in Example 1. In Example 6, the drying step was executed after the aqueous composition was applied to the sheet (substrate) in the application step. After the drying step, the printing step of applying the black ink as a printing ink onto the coating layer was executed.

### Example 7

It is different from Example 6 in that Mowinyl 6960 is used as the binder resin. Other conditions are the same as those in Example 6.

### Example 8

It is different from Example 1 in that 5.0 wt % of N,N′-(((2-acrylamido-2((3-(buta-1,3-diene-2-ylamino)propoxy-1,3-diyl)bis(oxy))bis(propane-3,1-diyl))diacrylamide is used as the polymerizable compound. Other conditions are the same as those in Example 1.

### Example 9

It is different from Example 8 in that 5.0 wt % of N,N-bis(2-acrylamidoethyl)acrylamide is used as the polymerizable compound. Other conditions are the same as those in Example 8.

### Example 10

It is different from Example 8 in that 5.0 wt % of N,N′-{oxybis(2,1-ethanediyloxy-3,1-propanediyl)}bisacrylamide is used as the polymerizable compound. Other conditions are the same as those in Example 8.

### Example 11

It is different from Example 1 in that N,N′-1,2-ethanediylbis{N-[2-(acryloylamino)ethyl]acrylamide} contained as the polymerizable compound in the aqueous composition is 1.0 wt %. Other conditions are the same as those in Example 1.

### Example 12

It is different from Example 11 in that N,N′-1,2-ethanediylbis{N-[2-(acryloylamino)ethyl]acrylamide} contained as the polymerizable compound in the aqueous composition is 2.5 wt %. Other conditions are the same as those in Example 11.

### Example 13

It different from Example 11 in that N,N′-1,2-ethanediylbis{N-[2-(acryloylamino)ethyl]acrylamide} contained as the polymerizable compound in the aqueous composition is 10.0 wt %. Other conditions are the same as those in Example 11.

### Example 14

It is different from Example 11 in that N,N′-1,2-ethanediylbis{N-[2-(acryloylamino)ethyl]acrylamide} contained as the polymerizable compound in the aqueous composition is 40.0 wt %. Other conditions are the same as those in Example 11.

### Example 15

It is different from Example 1 in that N,N′-1,2-ethanediylbis{N-[2-(acryloylamino)ethyl]acrylamide} contained as the polymerizable compound in the aqueous composition is 1.0 wt %, and the aqueous composition further contains 5.0 wt % of a carbon black dispersion liquid as a coloring material and 0.5 wt % of OLFINE E1010 as a surfactant. Other conditions are the same as those in Example 1. Note that, the carbon black dispersion liquid was prepared as follows. First, 40 g of carbon black “#2650” manufactured by Mitsubishi Chemical Corporation was mixed with 200 g of ion exchange water, followed by pulverization in a bead mill. A carboxy group agent was added thereto, followed by heating and stirring, and an oxidation treatment was carried out. Next, the obtained liquid was washed several times with a solvent, poured into water, washed again with water, and then filtered through a filter to obtain a carbon black dispersion liquid.

### Example 16

It is different from Example 1 in that the aqueous composition further contains 5.0 wt % of a carbon black dispersion liquid as the coloring material. Other conditions are the same as those in Example 1.

### Example 17

It is different from Example 1 in that the aqueous composition further contains 5.0 wt % of a carbon black dispersion liquid as the coloring material and 0.5 wt % of OLFINE E1010 as the surfactant. Other conditions are the same as those in Example 1.

### Example 18

It is different from Example 1 in that the dose of the electron beam for irradiation in the irradiation step is 10 kGy. Other conditions are the same as those in Example 1.

### Example 19

It is different from Example 1 in that the dose of the electron beam for irradiation in the irradiation step is 30 kGy. Other conditions are the same as those in Example 1.

### Example 20

It is different from Example 1 in that the lower surface of the sheet is irradiated with an electron beam in the irradiation step. Other conditions are the same as those in Example 1.

### Comparative Example 1

It is different from Example 1 in that the aqueous composition further contains 1.0 wt % of lithium phenyl-2,4,6-trimethylbenzoylphosphinate as a photopolymerization initiator excitable by ultraviolet light and the irradiation step is not carried out. Other conditions are the same as those in Example 1.

### Comparative Example 2

It is different from Example 1 in that the upper surface of the coating layer is irradiated with ultraviolet light having a peak wavelength of 395 nm for 10 seconds in the irradiation step. Other conditions are the same as those in Example 1. A UV-LED light [printing UV-LED series E075Z HC (manufactured by Ushio Inc.), 395 nm] was used as the ultraviolet irradiation device for emitting ultraviolet light.

### Comparative Example 3

It is different from Example 1 in that the aqueous composition is free of a polymerizable compound. Other conditions are the same as those in Example 1.

### Layer Formation Method

Hereinafter, the coating layer formed on the sheet using the aqueous composition was tested for fixability, durability, peelability, and odor.

### Fixability Test

In Examples 1 to 5 and 8 to 20 and Comparative Examples 1 to 3, in the application step, the aqueous composition was dropped onto the upper surface of the sheet using a dropper in an amount of 50 mg/cm², and in the drying step, the aqueous composition on the upper surface of the sheet was dried at a drying temperature of 90° C. for 3 hours, to form a coating layer made from the aqueous composition on the upper surface of the sheet. Thereafter, a fixability test was carried out, in which an adhesive tape was attached to an upper surface of the coating layer on the sheet and the adhesive tape was peeled off from the coating layer. In Examples 6 and 7, after the application step and the drying step, in the printing step, the black ink was dropped as a printing ink onto the upper surface of the coating layer using a dropper in an amount of 50 mg/cm² to form a coloring material layer on the upper surface of the coating layer. Thereafter, a fixability test was carried out, in which an adhesive tape was attached to an upper surface of a printing layer including the coating layer and the coloring material layer and the adhesive tape was peeled off from the printing layer. The sheet used was a PET film. The adhesive tape used was a cellophane tape [Cellulose Tape (registered trademark) CT-12 (manufactured by NICHIBAN Co., Ltd)]. “Cellulose Tape” is a registered trademark of NICHIBAN Co., Ltd. The fixability of the coating layer to the sheet was evaluated according to the following evaluation criteria.
A: did not peel off
B: peeled off

### Durability Test

The sheet was left for 2 weeks near a window exposed to direct sunlight, and the durability of the coating layer on the upper surface of the sheet was tested. The durability test was carried out under the following conditions.

Conditions: After leaving the sheet for 2 weeks near a window exposed to direct sunlight, the sheet and the coating layer (the printing layer in Examples 6 and 7) were folded in half and then returned to the original state, then an adhesive tape was attached to the upper surface of the sheet and the coating layer (the printing layer in Examples 6 and 7), and the adhesive tape was peeled off from the coating layer (the printing layer in Examples 6 and 7). Note that, when the sheet and the coating layer (the printing layer in Examples 6 and 7) were folded in half, cracks are generated in the coating layer, and thus the peelability can be improved. The adhesive tape used was a cellophane tape [Cellulose Tape (registered trademark) CT-12 (manufactured by NICHIBAN Co., Ltd)]. The durability of the coating layer was evaluated according to the following evaluation criteria.
A: did not peel off
B: peeled off

### Peelability Test

An electron beam emission window of the electron beam irradiation device was provided at a position 10 mm above a stage. In the irradiation step, the stage carrying the sheet was moved at a speed of 100 mm/see while the electron beam was emitted downward from the electron beam emission window, to irradiate the upper surface of the coating layer (the printing layer in Examples 6 and 7) with the electron beam. The electron beam irradiation device used was an electron beam irradiation device manufactured by Hamamatsu Photonics K.K. The oxygen concentration in the electron beam irradiation device was set to 100 ppm or less. An acceleration voltage was set to 100 kV. Thereafter, a peel test was carried out under the following two conditions.

Condition 1: An adhesive tape was attached to the upper surface of the sheet and the coating layer (the printing layer in Examples 6 and 7) after the irradiation with an electron beam, and the adhesive tape was peeled off from the coating layer (the printing layer in Examples 6 and 7).

Condition 2: The sheet and the coating layer (the printing layer in Examples 6 and 7) after the irradiation with an electron beam were folded in half and then returned to the original state, then an adhesive tape was attached to the upper surface of the sheet and the coating layer (the printing layer in Examples 6 and 7), and the adhesive tape was peeled off from the coating layer (the printing layer in Examples 6 and 7). Note that, when the sheet and the coating layer (the printing layer in Examples 6 and 7) were folded in half under the condition 2, cracks are generated in the coating layer, and thus the peelability can be improved. The adhesive tape used was a cellophane tape [Cellulose Tape (registered trademark) CT-12 (manufactured by NICHIBAN Co., Ltd)]. The peelability of the coating layer to the sheet was evaluated according to the following evaluation criteria.
A: peeled off under both the condition 1 and the condition 2
B: did not peel off under the condition 1, but peeled off under the condition 2
C: did not peel off under either the condition 1 or the condition 2

### Odor Test

In Examples 1 to 5 and 8 to 20 and Comparative Examples 1 and 2, the odor of the coating layer formed on the upper surface of the sheet through the application step and the drying step was evaluated according to the following evaluation criteria. In Examples 6 and 7, the odor of the coating layer having the coloring material layer formed on the upper surface through the application step, the drying step, and the printing step was evaluated according to the following evaluation criteria.
A: the operator hardly smells the odor with the sense of smell
B: the operator clearly smells the odor with the sense of smell

TABLE 1

| | | Example | Example | Example | Example | Example | Example | Example | Example |
|---|---|---|---|---|---|---|---|---|---|
| Composition 1 | | 1 | 2 | 3 | 4 | 5 | 6 | 7 | 8 |
| Photopolymer- | Photopolymerization | | | | | | | | |
| ization initiator | initiator 1 | | | | | | | | |
| (wt %) | | | | | | | | | |
| Polymerizable | Polymerizable | | | | | | | | 5 |
| compound | compound 1 | | | | | | | | |
| (wt %) | Polymerizable | | | | | | | | |
| | compound 2 | | | | | | | | |
| | Polymerizable | | | | | | | | |
| | compound 3 | | | | | | | | |
| | Polymerizable | 5 | 5 | 5 | 5 | 5 | 5 | 5 | |
| | compound 4 | | | | | | | | |
| Binder resin | Mowinyl 6760 | 5 | | | | | 5 | | 5 |
| (wt %) | Mowinyl 6960 | | 5 | | | | | 5 | |
| | Mowinyl 6901 | | | 5 | | | | | |
| | SUPERFLEX 460 | | | | 5 | | | | |
| | Mowinyl 6800 | | | | | 5 | | | |
| Coloring | Carbon black | | | | | | | | |
| material (wt %) | dispersion liquid | | | | | | | | |
| Organic | Propylene glycol | 10 | 10 | 10 | 10 | 10 | 10 | 10 | 10 |
| solvent (wt %) | | | | | | | | | |
| Surfactant | OLFINE E1010 | | | | | | | | |
| (wt %) | | | | | | | | | |
| Solvent (wt %) | Ion exchange water | Balance | Balance | Balance | Balance | Balance | Balance | Balance | Balance |
| Printing ink | Composition 2 | — | — | — | — | — | Black | Black | — |
| | (LC3139) | | | | | | ink | ink | |
| | | | | | | | dropping | dropping | |
| Substrate | | PET | PET | PET | PET | PET | PET | PET | PET |
| | | film | film | film | film | film | film | film | film |
| Drying temperature (° C.) | | 90 | 90 | 90 | 90 | 90 | 90 | 90 | 90 |
| Conditions in | Irradiation | On | On | On | On | On | On | On | On |
| irradiation with | surface | coating | coating | coating | coating | coating | coating | coating | coating |
| electron beam | | layer | layer | layer | layer | layer | layer | layer | layer |
| | Acceleration | 100 | 100 | 100 | 100 | 100 | 100 | 100 | 100 |
| | voltage (kV) | | | | | | | | |
| | Dose (kGy) | 60 | 60 | 60 | 60 | 60 | 60 | 60 | 60 |
| | Oxygen | 100 or | 100 or | 100 or | 100 or | 100 or | 100 or | 100 or | 100 or |
| | concentration | less | less | less | less | less | less | less | less |
| | (ppm) | | | | | | | | |
| Evaluation | Fixability | A | A | A | A | A | A | A | A |
| result | Durability (non- | A | A | A | A | A | A | A | A |
| | peelability in | | | | | | | | |
| | normal use) | | | | | | | | |
| | Peelability | A | A | A | A | A | A | A | A |
| | Odor | A | A | A | A | A | A | A | A |
| | | Example | Example | Example | Example | Example | Example | Example | Example |
| Composition 1 | | 9 | 10 | 11 | 12 | 13 | 14 | 15 | 16 |
| Photopolymer- | Photopolymerization | | | | | | | | |
| ization initiator | initiator 1 | | | | | | | | |
| (wt %) | | | | | | | | | |
| Polymerizable | Polymerizable | | | | | | | | |
| compound | compound 1 | | | | | | | | |
| (wt %) | Polymerizable | 5 | | | | | | | |
| | compound 2 | | | | | | | | |
| | Polymerizable | | 5 | | | | | | |
| | compound 3 | | | | | | | | |
| | Polymerizable | | | 1 | 2.5 | 10 | 40 | 1 | 5 |
| | compound 4 | | | | | | | | |
| Binder resin | Mowinyl 6760 | 5 | 5 | 5 | 5 | 5 | 5 | 5 | 5 |
| (wt %) | Mowinyl 6960 | | | | | | | | |
| | Mowinyl 6901 | | | | | | | | |
| | SUPERFLEX 460 | | | | | | | | |
| | Mowinyl 6800 | | | | | | | | |
| Coloring | Carbon black | | | | | | | 5 | 5 |
| material (wt %) | dispersion liquid | | | | | | | | |
| Organic | Propylene glycol | 10 | 10 | 10 | 10 | 10 | 10 | 10 | 10 |
| solvent (wt %) | | | | | | | | | |
| Surfactant | OLFINE E1010 | | | | | | | 0.5 | |
| (wt %) | | | | | | | | | |
| Solvent (wt %) | Ion exchange water | Balance | Balance | Balance | Balance | Balance | Balance | Balance | Balance |
| Printing ink | Composition 2 | — | — | — | — | — | — | — | — |
| | (LC3139) | | | | | | | | |
| Substrate | | PET | PET | PET | PET | PET | PET | PET | PET |
| | | film | film | film | film | film | film | film | film |
| Drying temperature (° C.) | | 90 | 90 | 90 | 90 | 90 | 90 | 90 | 90 |
| Conditions in | Irradiation | On | On | On | On | On | On | On | On |
| irradiation with | surface | coating | coating | coating | coating | coating | coating | coating | coating |
| electron beam | | layer | layer | layer | layer | layer | layer | layer | layer |
| | Acceleration | 100 | 100 | 100 | 100 | 100 | 100 | 100 | 100 |
| | voltage (kV) | | | | | | | | |
| | Dose (kGy) | 60 | 60 | 60 | 60 | 60 | 60 | 60 | 60 |
| | Oxygen | 100 or | 100 or | 100 or | 100 or | 100 or | 100 or | 100 or | 100 or |
| | concentration (ppm) | less | less | less | less | less | less | less | less |
| Evaluation | Fixability | A | A | A | A | A | A | A | A |
| result | Durability (non- | A | A | A | A | A | A | A | A |
| | peelability in | | | | | | | | |
| | normal use) | | | | | | | | |
| | Peelability | A | A | B | A | A | A | B | A |
| | Odor | A | A | A | A | A | A | A | A |

| | | Example | Example | Example | Example | Comparative | Comparative | Comparative |
|---|---|---|---|---|---|---|---|---|
| Composition 1 | | 17 | 18 | 19 | 20 | Example 1 | Example 2 | Example 3 |
| Photopolymer- | Photopolymer- | | | | | 1 | | |
| ization initiator | ization | | | | | | | |
| (wt %) | initiator 1 | | | | | | | |
| Polymerizable | Polymerizable | | | | | | | |
| compound | compound 1 | | | | | | | |
| (wt %) | Polymerizable | | | | | | | |
| | compound 2 | | | | | | | |
| | Polymerizable | | | | | | | |
| | compound 3 | | | | | | | |
| | Polymerizable | 5 | 5 | 5 | 5 | 5 | 5 | |
| | compound 4 | | | | | | | |
| Binder resin | Mowinyl 6760 | 5 | 5 | 5 | 5 | 5 | 5 | 5 |
| (wt %) | Mowinyl 6960 | | | | | | | |
| | Mowinyl 6901 | | | | | | | |
| | SUPERFLEX | | | | | | | |
| | 460 | | | | | | | |
| | Mowinyl 6800 | | | | | | | |
| Coloring | Carbon black | 5 | | | | | | |
| material (wt %) | dispersion liquid | | | | | | | |
| Organic solvent | Propylene glycol | 10 | 10 | 10 | 10 | 10 | 10 | 10 |
| (wt %) | | | | | | | | |
| Surfactant (wt %) | OLFINE E1010 | 0.5 | | | | | | |
| Solvent (wt %) | Ion exchange | Balance | Balance | Balance | Balance | Balance | Balance | Balance |
| | water | | | | | | | |
| Printing ink | Composition 2 | — | — | — | — | — | — | — |
| | (LC3139) | | | | | | | |
| Substrate | | PET film | PET film | PET film | PET film | PET film | PET film | PET film |
| Drying temperature (° C.) | | 90 | 90 | 90 | 90 | 90 | 90 | 90 |
| Conditions in | Irradiation | On | On | On | Under | No | On | On |
| irradiation with | surface | coating | coating | coating | substrate | irradiation | coating | coating |
| electron beam | | layer | layer | layer | | | layer | layer |
| | Acceleration | 100 | 100 | 100 | 100 | | Irradiation | 100 |
| | voltage (kV) | | | | | | with | 60 |
| | Dose (kGy) | 60 | 10 | 30 | 60 | | ultraviolet | 100 or |
| | Oxygen | 100 or | 100 or | 100 or | 100 or | | light | less |
| | concentration | less | less | less | less | | | |
| | (ppm) | | | | | | | |
| Evaluation | Fixability | A | A | A | A | A | A | A |
| result | Durability (non- | A | A | A | A | B | A | A |
| | peelability in | | | | | | | |
| | normal use) | | | | | | | |
| | Peelability | A | A | A | A | C | C | C |
| | Odor | A | A | A | A | B | A | A |

Photopolymerization initiator 1: lithium phenyl-2,4,6-trimethylbenzoylphosphinate
Polymerizable compound 1: N,N′-(((2-acrylamido-2((3-(buta-1,3-diene-2-ylamino)propoxy-1,3-diyl)bis(oxy))bis(propane-3,1-diyl))diacrylamide
Polymerizable compound 2: N,N-bis(2-acrylamidoethyl)acrylamide
Polymerizable compound 3: N,N′-{oxybis(2,1-ethanediyloxy-3,1-propanediyl)}bisacrylamide
Polymerizable compound 4: N,N′-1,2-ethanediylbis{N-[2-(acryloylamino)ethyl]acrylamide

### Fixability Test Evaluation

As shown in Table 1, in all of Examples 1 to 20 and Comparative Examples 1 to 3, no peeling occurred and therefore the evaluation was A. This is thought to be because the drying temperature in the drying step was 90° C., which was higher than the glass transition temperature of the binder resin, so that the binder resin in the aqueous composition was sufficiently soft and the film formation of the binder resin proceeded sufficiently, and as a result, the adhesion between the upper surface of the sheet and the binder resin was improved. In addition, the drying temperature in the drying step was set to 90° C. in order to prevent the sheet from being altered by heat.

### Durability Test Evaluation

As shown in Table 1, in all of Examples 1 to 20 and Comparative Examples 2 and 3, the coating layer was not peeled off and therefore the evaluation was A. This is thought to be because the aqueous composition was free of the photopolymerization initiator excitable by ultraviolet light, so that the polymerizable compound in the coating layer did not undergo a polymerization reaction when exposed to natural light. In contrast, in Comparative Example 1, the coating layer was peeled off and therefore the evaluation was B. This is thought to be because the aqueous composition contained 1.0 wt % of the photopolymerization initiator excitable by ultraviolet light, so that the polymerization reaction of the polymerizable compound in the coating layer proceeded to shrink the coating layer, and as a result, the adhesion force of the coating layer to the sheet decreased.

### Peelability Test Evaluation

As shown in Table 1, in all of Examples 1 to 20, peeling occurred under either the condition 1 or the condition 2, and therefore the evaluation was B or more. This is thought to be because in the irradiation step, the upper surface of the sheet on which the coating layer was formed was irradiated with an electron beam, and as a result, the polymerization reaction of the polymerizable compound in the coating layer proceeded to shrink the coating layer, so that the adhesion force of the coating layer to the sheet sufficiently decreased.

In contrast, in all of Comparative Examples 1 to 3, no peeling occurred under either the condition 1 or the condition 2, and therefore the evaluation was C. This is thought to be because, in the irradiation step in Comparative Example 1, the upper surface of the sheet on which the coating layer was formed was not irradiated with an electron beam, so that the polymerization reaction of the polymerizable compound in the coating layer did not proceed at all, and the adhesion force of the coating layer to the sheet did not decrease. This is thought to be because, in the irradiation step in Comparative Example 2, the upper surface of the coating layer was irradiated with ultraviolet light rather than an electron beam, so that the polymerization reaction of the polymerizable compound in the coating layer did not proceed at all, and the adhesion force of the coating layer to the sheet did not decrease. This is thought to be because, in Comparative Example 3, the aqueous composition was free of a polymerizable compound, so that the adhesion force of the coating layer to the sheet did not decrease even when the upper surface of the sheet on which the coating layer was formed was irradiated with an electron beam.

In addition, in Examples 11 and 15, peeling occurred under the condition 2 and therefore the evaluation was B, whereas in other Examples, peeling occurred under the condition 1 and therefore the evaluation was A. This is thought to be because, in Examples 11 and 15, the polymerizable compound contained in the aqueous composition was 1.0 wt %, whereas in other Examples, the polymerizable compound contained in the aqueous composition was 5.0 wt %, and the wt % of the polymerizable compound contained in the aqueous compositions in Examples 11 and 15 was lower than that of other Examples.

### Odor Test Evaluation

As shown in Table 1, in all of Examples 1 to 20, the operator hardly smelled the odor with the sense of smell, and therefore the evaluation was A. This is thought to be because, in Examples 1 to 20, the aqueous composition was free of the photopolymerization initiator excitable by ultraviolet light. In contrast, in Comparative Example 1, the operator clearly smelled the odor with the sense of smell, and therefore the evaluation was B. This is thought to be because, in Comparative Example 1, the aqueous composition contained 1.0 wt % of the photopolymerization initiator excitable by ultraviolet light.

As seen from the above, in the case where the aqueous composition containing the polymerizable compound is free of the photopolymerization initiator excitable by ultraviolet light, the aqueous composition is dried in the drying step, and the coating layer on the upper surface of the sheet is irradiated with an electron beam in the irradiation step, the evaluation for the fixability is A and the evaluation for the peelability is A. It is also seen that when the aqueous composition containing the polymerizable compound is free of the photopolymerization initiator excitable by ultraviolet light, the evaluation for the durability is A and the evaluation for the odor is A.

What is claimed is:

1. A layer formation method comprising:
an application step of applying or ejecting, onto a substrate, an aqueous composition containing water and a polymerizable compound that is soluble in water and that undergoes a polymerization reaction due to irradiation with an electron beam; and
a drying step of drying the aqueous composition applied or ejected onto the substrate, wherein
the aqueous composition is free of a photopolymerization initiator excitable by ultraviolet light, and
a coating layer, which is peelable from the substrate, is formed on the substrate using the aqueous composition.

2. The layer formation method according to claim 1, wherein in the application step, the aqueous composition is ejected onto the substrate by an inkjet head.

3. The layer formation method according to claim 1, wherein the coating layer is a printing layer.

4. The layer formation method according to claim 1, wherein
the aqueous composition is an aqueous ink containing a coloring material, and
the application step is a printing step of applying or ejecting the aqueous ink onto the substrate.

5. The layer formation method according to claim 1, further comprising:
a printing step of applying or ejecting a printing ink onto the coating layer obtained by application or ejection onto the substrate, wherein
the drying step is executed after the printing step or between the application step and the printing step.

6. The layer formation method according to claim 1, wherein
the aqueous composition contains a binder resin for forming the coating layer, and
the drying step is a step of drying the aqueous composition applied or ejected onto the substrate in the application step at a temperature in a range of 50° C. to 220° C.

7. The layer formation method according to claim 1, wherein
the aqueous composition contains a binder resin for forming the coating layer, and
the drying step is a step of drying the aqueous composition applied or ejected onto the substrate in the application step at a temperature in a range of 50° C. to 150° C.

8. The layer formation method according to claim 1, wherein the aqueous composition contains a binder resin for forming the coating layer, and is in an emulsion state where the binder resin is dispersed in the water.

9. The layer formation method according to claim 8, wherein the substrate is a non-permeable substrate.

10. The layer formation method according to claim 9, wherein the substrate is a transparent substrate.

11. A substrate regeneration method comprising:
an irradiation step of irradiating the coating layer formed by using the layer formation method according to claim 1 with an electron beam at a dose in a range of 1 kGy to 150 kGy.

12. A substrate regeneration method comprising:
an irradiation step of irradiating the coating layer formed by using the layer formation method according to claim 1 with an electron beam at a dose in a range of 30 kGy to 100 kGy.

13. The substrate regeneration method according to claim 11, wherein the irradiation step is a step of irradiating, with the electron beam, a surface of the substrate on which the coating layer is formed.

14. The substrate regeneration method according to claim 12, wherein the irradiation step is a step of irradiating, with the electron beam, a surface of the substrate on which the coating layer is formed.

15. The substrate regeneration method according to claim 11, wherein in the irradiation step, a back surface of the substrate opposite to a surface of the substrate on which the coating layer is formed is irradiated with the electron beam.

16. The substrate regeneration method according to claim 12, wherein in the irradiation step, a back surface of the substrate opposite to a surface of the substrate on which the coating layer is formed is irradiated with the electron beam.

17. A printed matter production method comprising:
an application step of applying or ejecting, onto a substrate, an aqueous composition containing water and a polymerizable compound that is soluble in water and that undergoes a polymerization reaction due to irradiation with an electron beam; and
a drying step of drying the aqueous composition applied or ejected onto the substrate, wherein
the aqueous composition is free of a photopolymerization initiator excitable by ultraviolet light, and
a printing layer, which is peelable from the substrate, is formed on the substrate using the aqueous composition.

18. The printed matter production method according to claim 17, wherein the aqueous composition contains a binder resin, and is in an emulsion state where the binder resin is dispersed in the water.

19. The printed matter production method according to claim 17, wherein the substrate is a transparent non-permeable substrate.
